(19) United States
(12) Patent Application Publication
(10) Pub. No.: US 2026/0237808 A1
(43) Pub. Date: Aug. 13, 2026

(54) BATTERY PACK ENCLOSURE WITH COMPOSITE PANEL

(71) Applicant: Ford Global Technologies, LLC, Dearborn, MI (US)

(72) Inventors: Bhaskara Rao Boddakayala, Troy, MI (US); Druva Krishnaswami, Detroit, MI (US); Ali Saad, Troy, MI (US)

(21) Appl. No.: 19/534,883

(22) Filed: Feb. 10, 2026

Related U.S. Application Data
(60) Provisional application No. 63/756,863, filed on Feb. 11, 2025.

(51) Int. Cl. H01M 50/209; H01M 50/224

(52) U.S. Cl. CPC H01M 50/209; H01M 50/224

(57) ABSTRACT

A traction battery enclosure assembly includes an enclosure assembly defining an interior configured to receive a plurality of battery cells, and an enclosure component of the enclosure assembly. The enclosure component includes a first region formed of a composite panel and a second region that is different than the first region. The second region definiens an opening that receives the first region.

### CROSS REFERENCE TO RELATED APPLICATIONS

This disclosure claims priority to U.S. Provisional Application No. 63/756,863, filed February 11, 2025, which is incorporated herein by reference in its entirety.

### TECHNICAL FIELD

This disclosure relates generally to an enclosure of a traction battery pack and, more particularly, to an enclosure having a composite region.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. A traction battery of an electrified vehicle can include battery cells arranged in one or more arrays with an enclosure.

### SUMMARY

In some aspects, the techniques described herein relate to a traction battery enclosure assembly, including: an enclosure assembly defining an interior configured to receive a plurality of battery cells; and an enclosure component of the enclosure assembly, the enclosure component including a first region formed of a composite panel and a second region that is different than the first region, the second region defining an opening that receives the first region.

In some aspects, the techniques described herein relate to a traction battery enclosure assembly, wherein the second region extends circumferentially about an entire perimeter of the first region.

In some aspects, the techniques described herein relate to a traction battery enclosure assembly, wherein the composite panel provides a vent reaction surface facing at least one vent of at least one battery cell within the plurality of battery cells.

In some aspects, the techniques described herein relate to a traction battery enclosure assembly, wherein the second region is a metallic frame.

In some aspects, the techniques described herein relate to a traction battery enclosure assembly, wherein the first region is received such that the composite panel

extends through the opening, wherein a first portion of the composite panel extends beyond the opening and along an outer surface of the composite panel, wherein a second portion of the composite panel extends beyond the opening and along an underside surface of the metallic frame.

In some aspects, the techniques described herein relate to a traction battery enclosure assembly, wherein the enclosure component is a first enclosure component that is secured to a second enclosure component through the second region.

In some aspects, the techniques described herein relate to a traction battery enclosure assembly, further including a plurality of fasteners each extending through a respective aperture in the second region to secure the first enclosure component to the second enclosure component.

In some aspects, the techniques described herein relate to a traction battery enclosure assembly, wherein the first enclosure component is an enclosure cover and the second enclosure component is an enclosure tray.

In some aspects, the techniques described herein relate to a traction battery enclosure assembly, wherein the composite panel includes a multilayer construction including: first and second polymer-based layers, layers of randomly chopped glass fibers between the first and second polymer-based layers, and a metallic mesh layer between the layers of randomly chopped glass fibers.

In some aspects, the techniques described herein relate to a traction battery enclosure assembly, wherein the composite panel is positioned to receive vent byproducts from at least one of the battery cells.

In some aspects, the techniques described herein relate to a traction battery enclosure assembly, wherein the second region is a metallic frame, wherein the first region is received such that the composite panel extends through the opening, wherein a first portion of the composite panel extends beyond the opening and along an outer surface of the metallic frame, wherein a second portion of the composite panel extends beyond the opening and along an underside surface of the metallic frame.

In some aspects, the techniques described herein relate to a traction battery enclosure assembly, wherein the first and second polymer-based layers are spray transfer molded first and second polymer-based layers.

In some aspects, the techniques described herein relate to a traction battery enclosure assembly, wherein the first and second polymer-based layers include a polymer matrix and a plurality of discontinuous reinforcement fibers dispersed within the polymer matrix.

In some aspects, the techniques described herein relate to a traction battery enclosure assembly, including: a plurality of battery cells; an enclosure assembly defining an interior configured to receive the plurality of battery cells; and an enclosure component of the enclosure assembly, the enclosure component including a frame that holds a composite panel such that the composite panel overlies the plurality of battery cells and is positioned such that vent byproducts from at least one of the battery cells is directed against the composite panel during a venting event.

In some aspects, the techniques described herein relate to a traction battery enclosure assembly, wherein the composite panel is a multilayer construction including: polyurethane spray layers, layers of randomly chopped glass fibers embedded within the polyurethane spray layers, and a steel mesh layer between the layers of randomly chopped glass fibers.

In some aspects, the techniques described herein relate to a traction battery enclosure assembly, wherein the composite panel is mechanically retained within an opening defined by the frame, the frame extending about an entire circumferential perimeter of the composite panel.

In some aspects, the techniques described herein relate to a traction battery enclosure assembly, wherein the enclosure component is an enclosure cover, the enclosure cover secured to an enclosure tray using a plurality of fasteners that secure together the frame and the enclosure tray.

In some aspects, the techniques described herein relate to a traction battery pack enclosure component providing method, including: spraying at least one layer of a polymer-based material onto at least one base layer to provide a multilayered blank; and securing the multilayered blank within an opening of a frame to provide a battery pack enclosure component.

In some aspects, the techniques described herein relate to a traction battery pack enclosure component providing method, wherein the spraying and securing are steps in a spray transfer molding process.

In some aspects, the techniques described herein relate to a traction battery pack enclosure component providing method, wherein securing includes pressing the multilayered blank into the opening using mold tooling, and then curing the at least one layer of a polymer-based material cures within a mold cavity of the mold tooling.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 is a side view of an electrified vehicle having a traction battery pack.

FIG. 2 illustrates an expanded view of the traction battery pack of FIG. 1 showing an enclosure assembly that receives a plurality of battery cells.

FIG. 3 illustrates a top view of the traction battery pack of FIG. 1.

FIG. 4 illustrates a section view taken at line 4–4 in FIG. 3.

FIGS. 5A–5D illustrates close-up views of the section shown in FIG. 4 and showing a multilayer structure of the enclosure assembly according to different exemplary embodiments of the present disclosure.

FIGS. 6A–6E illustrates selected steps in an example method of providing an enclosure component of the assembly of FIG. 2 according to an exemplary embodiment of the present disclosure.

### DETAILED DESCRIPTION

This disclosure details a component of an enclosure assembly. The component includes at least one composite panel. The inclusion of the composite panel can reduce an overall weight of the enclosure component. The component can be an enclosure cover.

With reference to FIG. 1, an electrified vehicle 10 includes a traction battery pack 12, an electric machine 14, and wheels 16. The battery pack 12 powers the electric

machine 14, which converts electric power to torque to drive the wheels 16. The battery pack 12 is a traction battery pack as the battery pack 12 is used for electric propulsion.

The battery pack 12 is, in the exemplary embodiment, secured to an underbody 18 of the electrified vehicle 10 beneath and outside a passenger compartment of the electrified vehicle 10. The battery pack 12 could be located elsewhere on the electrified vehicle 10 in other examples.

The example vehicle 10 is a battery electric vehicle (BEV). In another example, the vehicle 10 could be another type of electrified vehicle, such as a hybrid electric vehicle (HEV), plug-in hybrid electric vehicle (PHEV), or a conventional vehicle. In some examples, the vehicle 10 is an Extended Range Electric Vehicle (EREV) where the vehicle is propelled by one or more electric traction motors powered by the battery pack and an onboard engine-generator system selectively generates electrical energy to extend vehicle driving range by recharging the battery pack. Generally, the electrified vehicle 10 could be any type of vehicle having a traction battery pack.

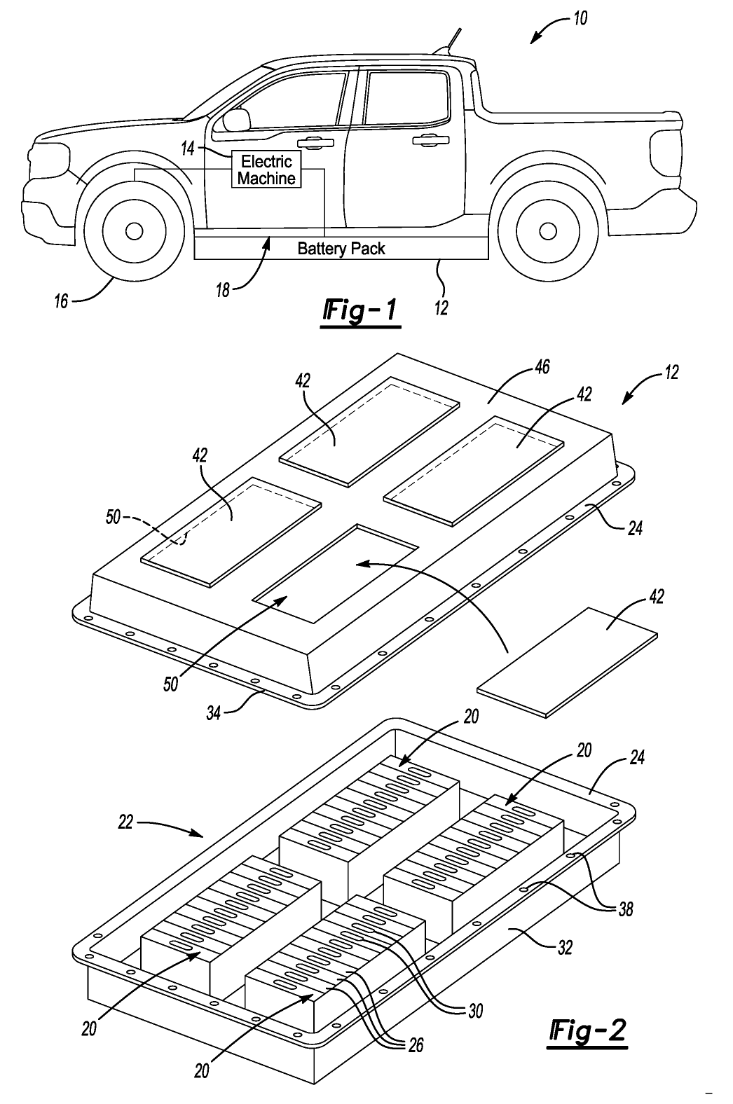

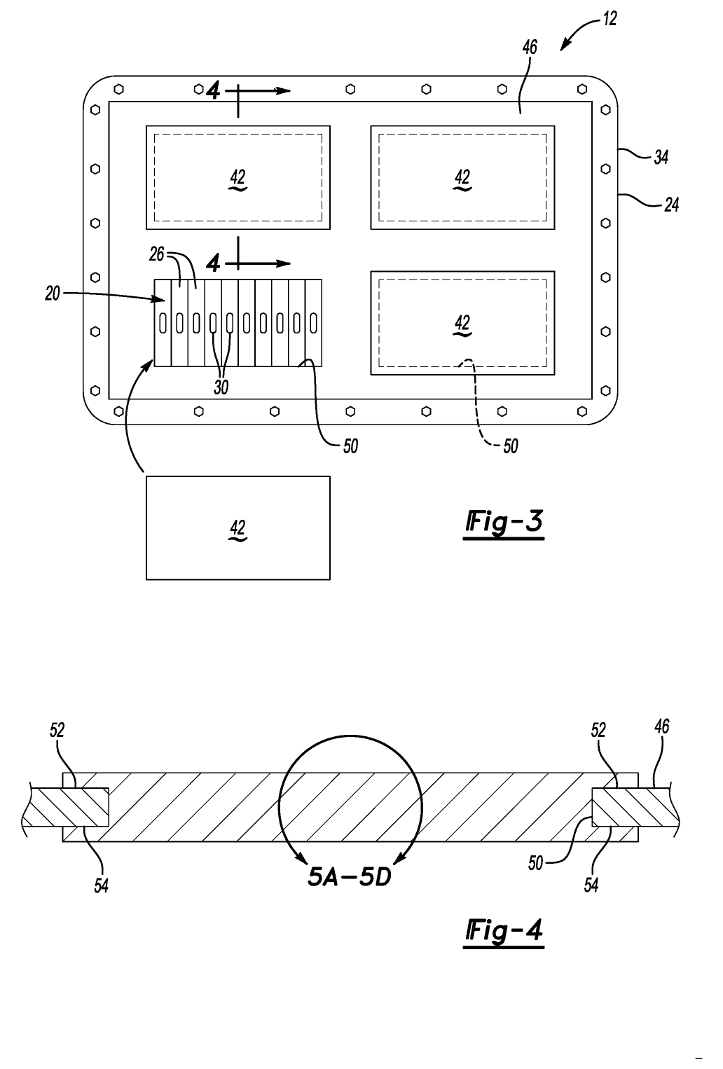

Referring now to FIGS. 2 and 3 with continuing reference to FIG. 1, the battery pack 12 includes a plurality of cell stacks 20 housed within an interior area 22 of an enclosure assembly 24. The cell stacks 20 each include groups of individual battery cells 26 arranged in rows. In an embodiment, the battery cells 26 are lithium-ion prismatic cells. However, battery cells having other geometries (cylindrical, pouch, etc.), other chemistries (nickel-metal hydride, lead-acid, etc.), or both could alternatively be utilized within the scope of this disclosure.

The battery cells 26 each include a vent 30. During a thermal event, one or more of the vents 30 can rupture to discharge vent byproducts from within the associated battery cell 26 and relieve pressure within the battery cell 26. The vent byproducts can include particulate matter and relatively high levels of thermal energy.

In this example, the enclosure assembly 24 includes a plurality of enclosure components. The enclosure components include, in this example, an enclosure tray 32 and an enclosure cover 34. A plurality of mechanical fasteners 36 extend through apertures 38 in the enclosure cover 34 to secure the enclosure cover 34 to the enclosure tray 32. When the enclosure cover 34 is secured to the enclosure tray 32, the enclosure assembly 24 completely encloses the cell stacks 20 within the interior area.

The enclosure cover 34 includes one or more first regions 42 held by a second region 46. The first regions 42 can each be retained within a respective window or opening 50 provided by the second region 46. In this example, one of the first regions 42 is aligned with each of the cell stacks 20. The first regions 42 are held in a position such that the first regions 42 span over the vents 30 of the battery cells 26. The second region 46 extends completely around each of the openings 50 in this example. Thus, the first region 42 interfaces with the second regions 46 about an entire circumferential perimeter of the first regions 42. The first region 42 provides a frame that holds or otherwise supports the second regions 46 in the desired positions.

The first regions 42 are positioned such that vent byproducts discharged through the vent 30 of one or more of the battery cells 26 impinge upon the first region 42. The first regions 42 thus provide a vent reaction surface that face at least some of the vents 30. This arrangement such that the vent byproducts directly impinge upon the first region 42 can provide design flexibility as the first region 42 and its construction can be designed to, among other things, accommodate the vent byproducts. The first region 42 can be, for example, designed to resist thermal energy, to insulate, to shield, etc.

With reference now to FIGS. 4, the first regions 42 of the example embodiment are composite panels having a multilayered structure. The second region 46 is a different material than the first region 42. In this example, the second region 46 is a metal or metal alloy such as an E-coated steel material. In addition to added design flexibility, the usage of the first region 42 formed of the composite panels or multilayered structures reduces the overall weight of the enclosure cover 34 when compared to an enclosure cover made entirely of the material of the second region 46.

In the example embodiment, the apertures 38 that receive the fasteners 36 are provided within the second region 46 of the enclosure cover 34. This enables the fasteners 36 to secure together the enclosure cover 34 and the enclosure tray 32 via a hard joint.

An edge portion of the second region 46 is embedded within the first region 42. A portion of the first region 42 extends beyond the respective opening 50 along an outer surface 52 of the second region 46. A second portion of the first region 42 extends beyond the opening 50 along an underside surface 54 of the second region 46. The first region 42 is thicker than the second region 46, which facilitates the overlapping of the first region 42 with the outer surface 52 and the underside surface 54.

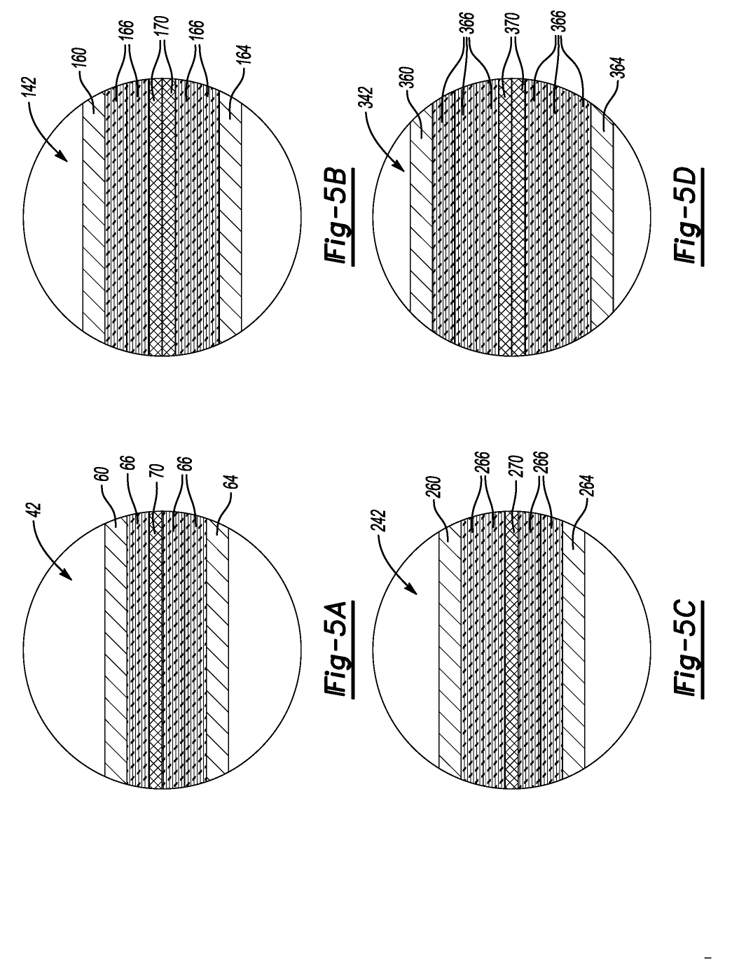

With reference to FIG. 5A, in the exemplary embodiment, the multilayered structure of the first region 42 include an outer first polymer-based layer 60 and a second outer polymer-based layer 64. The first outer polymer-based layer 60 and the second outer polymer-based layer 64 are polyurethane materials each weighing 900 grams per square meter.

The multilayered construction of the first region 42 further includes at least one inner layer 66 of, for example, randomly chopped glass fibers. A core layer 70 can be positioned between the inner layer 66. The core layer 70 can be a metal mesh layer. In some examples, the core layer 70 can be a steel mesh that is 100 microns, and the inner layers 66, which are randomly shopped glass fiber layers, can each weight 450 grams per square meter. In the FIG. 5A embodiment, one inner layer 66 is between the outer layer 60 and the core layer 70, and two inner layers 66 are between the outer layer 64 and the core layer 70.

In some examples, the first region 42 can include one core layer 70, or more than one core layer 70. Further, one inner layer 66 could be positioned between the first outer polymer-based layer 60 and the core layer 70, or more than one inner layer 66 could be position between the first outer polymer-based layer 60 and the core layer 70. Similarly, one, or more than one inner layer 66 could be positioned between the second outer polymer-based layer 60 and the core layer 70.

In the FIG. 5B embodiment, a first region 142 includes two core layers 170. Two inner layers 166 are between the outer layer 160 and the core layers 170, and two inner layers 166 are between the inner layer 164 and the core layers 170. Utilizing more layers can increase a thickness of the first region 142 when compared to the first region 42 of the FIG. 5A example.

In the FIG. 5C embodiment, a first region 242 includes one core layer 270. Two inner layers 266 are between the outer layer 260 and the core layers 270, and two inner layers 266 are between the inner layer 264 and the core layers 270.

In the FIG. 5D embodiment, a first region 342 includes two core layers 370. three inner layers 366 are between the outer layer 360 and the core layers 370, and three inner layers 366 are between the inner layer 364 and the core layers 370. An overall thickness of the first region 342 can be 4.5 millimeters in some examples.

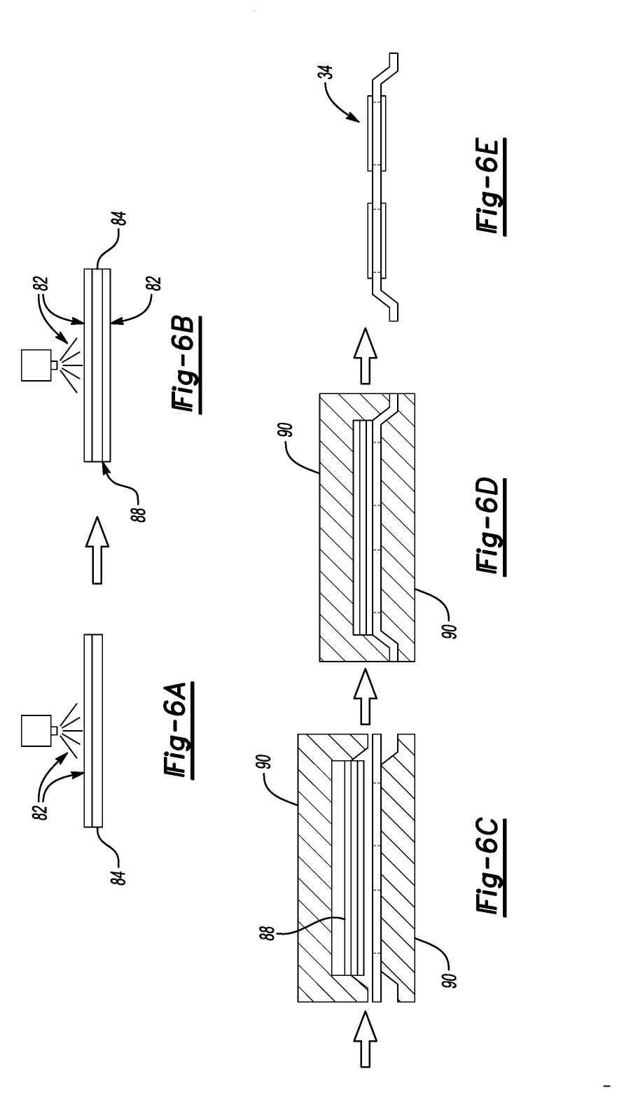

With reference now to FIGS. 6A–6E, a method of constructing an enclosure component, such as the enclosure cover 34 of FIGS. 1–5, utilizes a spray transfer molding process. In one example, a core layer 70 and one or more inner layers 66 are assembled to establish a base layer 84, with the inner layers 66 impregnated into the core layer 70. Both sides are then sprayed with at least one layer of an atomized polymer-based material 82 as shown in FIGS. 6A and 6B.

The polymer-based material sprayed onto both sides of that base layer to provide what will become the first outer layer 60 and the second outer layer 64. The base layer sprayed with the polymer-based material can be considered a multilayered blank 88.

The multilayered blank 88 can be positioned within a mold cavity provided by mold tooling 90 as shown in FIG. 6C. The mold tooling 90 is actuated to press the multilayered blank into openings in a frame and to form the multilayered blank 88 and frame into a desired shape as shown in FIG. 6D.

After the polymer-based material cures to provide the first outer layer 60 and the second outer layer 64, the enclosure cover 34 can be removed from the mold cavity as shown in FIG. 6E.

Specifying that the first outer layer 60 and the second outer layer 64 are spray transfer molded layers describes structural characteristics of those layers. A person having ordinary skill in the art and the benefit of this disclosure would be able to identify a multilayered component resulting from a spray transfer molding process and structurally distinguish that component from a multilayered component formed by another process. In particular, a spray transfer molded layer can be characterized by a polymer matrix having a plurality of discontinuous reinforcement fibers dispersed throughout the polymer matrix, with the fibers being randomly oriented and having lengths shorter than continuous or woven reinforcements, and with a generally uniform distribution through a thickness of the layer. These characteristics differ from layers formed by prepreg layup, woven fabric lamination, compression molding, or resin transfer molding, which exhibit continuous fiber architectures, layered ply interfaces, or ordered fiber orientations.

The structural characteristics associated with the spray transfer molded layers remain present regardless of the specific materials selected or operating parameters employed. Accordingly, recitation of a spray transfer molded layer defines a layer having a distinct and identifiable structure, rather than merely describing a method by which the layer was produced.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery enclosure assembly, comprising:
an enclosure assembly defining an interior configured to receive a plurality of battery cells; and
an enclosure component of the enclosure assembly, the enclosure component including a first region formed of a composite panel and a second region that is different than the first region, the second region defining an opening that receives the first region.

2. The traction battery enclosure assembly of claim 1, wherein the second region extends circumferentially about an entire perimeter of the first region.

3. The traction battery enclosure assembly of claim 1, wherein the composite panel provides a vent reaction surface facing at least one vent of at least one battery cell within the plurality of battery cells.

4. The traction battery enclosure assembly of claim 1, wherein the second region is a metallic frame.

5. The traction battery enclosure assembly of claim 4, wherein the first region is received such that the composite panel extends through the opening, wherein a first portion of the composite panel extends beyond the opening and along an outer surface of the composite panel, wherein a second portion of the composite panel extends beyond the opening and along an underside surface of the metallic frame.

6. The traction battery enclosure assembly of claim 1, wherein the enclosure component is a first enclosure component that is secured to a second enclosure component through the second region.

7. The traction battery enclosure assembly of claim 6, further comprising a plurality of fasteners each extending through a respective aperture in the second region to secure the first enclosure component to the second enclosure component.

8. The traction battery enclosure assembly of claim 6, wherein the first enclosure component is an enclosure cover and the second enclosure component is an enclosure tray.

9. The traction battery enclosure assembly of claim 1, wherein the composite panel comprises a multilayer construction including:
first and second polymer-based layers,
layers of randomly chopped glass fibers between the first and second polymer-based layers, and
a metallic mesh layer between the layers of randomly chopped glass fibers.

10. The traction battery enclosure assembly of claim 9, wherein the composite panel is positioned to receive vent byproducts from at least one of the battery cells.

11. The traction battery enclosure assembly of claim 10, wherein the second region is a metallic frame, wherein the first region is received such that the composite panel extends through the opening, wherein a first portion of the composite panel extends beyond the opening and along an outer surface of the metallic frame, wherein a second portion of the composite panel extends beyond the opening and along an underside surface of the metallic frame.

12. The traction battery enclosure assembly of claim 9, wherein the first and second polymer-based layers are spray transfer molded first and second polymer-based layers.

13. The traction battery enclosure assembly of claim 9, wherein the first and second polymer-based layers comprise a polymer matrix and a plurality of discontinuous reinforcement fibers dispersed within the polymer matrix.

14. A traction battery enclosure assembly, comprising:
a plurality of battery cells;
an enclosure assembly defining an interior configured to receive the plurality of battery cells; and
an enclosure component of the enclosure assembly, the enclosure component including a frame that holds a composite panel such that the composite panel overlies the plurality of battery cells and is positioned such that vent byproducts from at least one of the battery cells is directed against the composite panel during a venting event.

15. The traction battery enclosure assembly of claim 14, wherein the composite panel is a multilayer construction including:
polyurethane spray layers,
layers of randomly chopped glass fibers embedded within the polyurethane spray layers, and
a steel mesh layer between the layers of randomly chopped glass fibers.

16. The traction battery enclosure assembly of claim 14, wherein the composite panel is mechanically retained within an opening defined by the frame, the frame extending about an entire circumferential perimeter of the composite panel.

17. The traction battery enclosure assembly of claim 14, wherein the enclosure component is an enclosure cover, the enclosure cover secured to an enclosure tray using a plurality of fasteners that secure together the frame and the enclosure tray.

18. A traction battery pack enclosure component providing method, comprising:
spraying at least one layer of a polymer-based material onto at least one base layer to provide a multilayered blank; and
securing the multilayered blank within an opening of a frame to provide a battery pack enclosure component.

19. The traction battery pack enclosure component providing method of claim 18, wherein the spraying and securing are steps in a spray transfer molding process.

20. The traction battery pack enclosure component providing method of claim 18, wherein securing includes pressing the multilayered blank into the opening using mold tooling, and then curing the at least one layer of a polymer-based material cures within a mold cavity of the mold tooling.
